(19) United States
(12) Patent Application Publication
(10) Pub. No.: US 2007/0079238 A1
(43) Pub. Date: Apr. 5, 2007

(54) Computer executable graphical user interface engine, system, and method therefor

(75) Inventor: Kurt Weinkauff, High Ridge, MO (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/244,431

(22) Filed: Oct. 5, 2005

(51) Int. Cl. G06F 3/00

(52) U.S. Cl. 715/700; 715/764

(57) ABSTRACT

A computer executable graphical user interface engine receives one or more text-based files and generates a user interface at least partially populated with data from the one or more text-based files. The computer executable graphical user interface engine enforces updates retrievable via a network from a remote device based on date information related to the one or more text-based files.

### BACKGROUND

1. Field of the Disclosure

The present disclosure generally relates to graphical user interfaces for computing devices.

2. Description of the Related Art

Generally, over the past decade, more and more corporate enterprise software applications have been designed or redesigned for use over networks, including wide area networks such as the Internet (or World Wide Web). Such Internet-based applications typically allow remote access using a web-based browser and provide a platform for enabling business transactions. However, conventional web-based systems fail to serve all users equally well.

For example, mobile users, such as mobile sales employees, remote users, and the like, may not always have access to the network or may only have intermittent access, but they may still need use of the application and the associated data. Traditional web-based on-line applications may not be available to mobile and disconnected users when they are unable to connect to the network.

Custom software applications are typically compiled programs. However, to enact changes to the custom software, the application logic is edited and the program recompiled. In many business environments, small changes may occur daily, which means that compiled solutions may be impractical. In particular, conventional programs require programming resources for defining the way in which the application handles data, the rules that control its operation, and the communications between the application and other applications and/or data sources. Even small changes to compiled applications can be relatively time-consuming and expensive, and most businesses do not have sufficient programming resources to develop such applications from scratch.

One technique for providing web-based content off-line involves the use of plugins, which operate in conjunction with a web browser when a particular uniform resource locator (URL) address is selected by the user. However, like custom software programs, this approach also is a compiled application and requires programming resources to alter. Moreover, plugins are dependent on a web browser. If the browser is unstable or has security problems, those problems are translated to the plugin. Additionally, when the user upgrades his or her browser, the plugin may need to be reinstalled, which may cause additional support-related issues for corporate information technology support professionals, both in terms of help desk support and functionality issues. Furthermore, since the plugins are dependent on a particular Internet-browser, browser upgrades may impact performance of the plugin, requiring re-coding and re-compilation.

Therefore, there is an on-going need for an application interface for off-line computing access and that can be readily and quickly adjusted for customization and/or to adopt new business logic.

### BRIEF DESCRIPTION OF THE DRAWINGS

FIG. 1 is a simplified block diagram of a system with a client-device containing a GUI engine for selective off-line operations on distributed application

FIG. 2 is a simplified block diagram of a device for operation of a computer executable graphical user interface engine and for user interactions with application

FIG. 3 is a simplified block diagram illustrating different applications bundles on the user device of FIG. 2.

FIG. 4 is a simplified flow diagram for dynamic creation of a user interface based on application bundles.

FIGS. 5-9 illustrate screen depictions of a graphical user interface generated from the application bundles.

FIGS. 10-12 illustrate a simplified flow diagram of a GUI engine login process.

FIGS. 13 and 14 illustrate a simplified flow diagram illustrating one possible interaction of a user with a GUI engine.

FIG. 15 is a block diagram that is representative of a general computer system.

The use of the same reference symbols in different drawings indicates similar or identical items.

### DETAILED DESCRIPTION

According to one embodiment, a computer executable graphical user interface engine receives one or more text-based files and generates a user interface related to the one or more text-based files. The user interface may include input forms at least partially populated with data from the one or more text-based files. The computer executable graphical user interface engine enforces updates from a remote device based on date information related to the one or more text-based files

In another embodiment, a computer executable application includes a plurality of application bundles and a graphical user interface engine. Each application bundle has at least one associated text-based file defining application logic for a particular application. The graphical user interface engine receives selected application bundles and generates a corresponding number of user interfaces. Each user interface has features defined for the selected application bundle within the at least one associated text-based file and at least one user selectable function common to each of the user interfaces.

In another embodiment, a method of dynamically assembling an application from text-based files is provided. At least one text-based file is received using a graphical user interface engine. A local properties file is checked to determine if the at least one text-based file is valid. If the at least one text-based file is valid, a user interface is built for user interactions from the at least one text-based file. In one embodiment, the graphical user interface engine prohibits use of outdated information. In another embodiment, the user interface includes user selectable functions defined within the graphical user interface engine.

Generally, a graphical user interface (GUI) engine application dynamically generates a graphical user interface from a stored application bundle. The generated graphical user interface includes business logic and associated operations defined within the stored application bundle, which can be executed by the generated user interface based on user interactions. Each application bundle includes a text-based file describing interface form construction details, equations and values for fields within the interface form, and external data to be used in completing equations within the form. The GUI engine application can be selectively coupled to a network to retrieve new or updated application bundles and associated data and/or to upload stored data from a local device to a database on a network. In one embodiment, the GUI engine application is a stand-alone computer executable software application that operates within an operating system of a user device 102.

The GUI engine application may include an application manager for synchronizing stored or cached data associated with an application bundle data stored in one or more databases on the network. Additionally, the GUI engine application may generate user interfaces for multiple application bundles. The application manager manages user interactions between a user and the multiple user interfaces and between the multiple user interfaces and a network when the user device is coupled to the network.

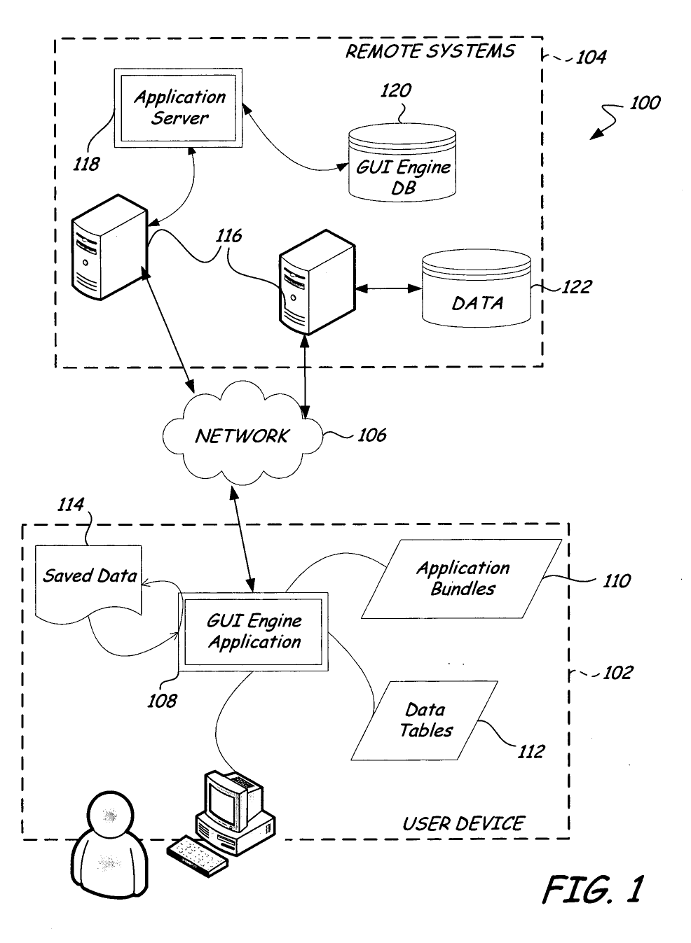

FIG. 1 illustrates a system 100 for providing a computer executable, stand-alone, GUI engine application to a plurality of users over a network for facilitating user interactions in both on-line and off-line modes. The system 100 includes one or more user devices 102 and one or more remote systems 104 selectively coupled over network 106, such as the Internet, a local area network (LAN), a wireless network, and the like.

User device 102 includes a GUI engine application 108, one or more screen bundles (application bundles) 110, one or more data tables 112, and saved data 114. The GUI engine application 108 can execute over the network 106 (on-line) or when disconnected from the network 106 (off-line). However, the GUI engine application 108 can only retrieve new or updated application bundles 110 or new or updated data tables 112 when connected to remote systems 104 via network 106. In general, the GUI engine application 108 downloads one or more application bundles 110 responsive to user selections. For example, if a user visits a corporate network using a web-based browser, the user may download the GUI engine application 108 along with an application bundle 110. Subsequently, the user may download additional application bundles 110, either through menu options within the GUI engine application 108 or via a web browser, without downloading the GUI engine application 108. The application bundles 110 extend the functionality of the GUI engine application 108 to perform various logical and data operations based on the downloadable application bundles 110, without having to alter the GUI engine application 108.

Application bundles 110 may contain screen layouts and field functionality, as well as help system contents for each distributed application. The GUI engine application 108 parses the application bundles 110 to derive user interface elements, including form elements, objects, buttons and the like, and to determine associated functionalities. Data tables 112 contain data to populate a user interface generated from an application bundle 110 by the GUI engine application 108. If multiple application bundles 110 are available, the data tables 112 may contain data for each of the application bundles 110.

The GUI engine application 108 can utilize the data tables 112 to populate forms and/or various equations within a user interface generated by the GUI engine application 108 based on one or more of the application bundles 110. The data tables 112 may be retrieved as part of an application bundle 110 and extracted by the GUI engine application or may be separately downloaded from or accessed through the one or more remote systems 104 by the GUI engine application 108. A user can interact with the data within the user interface and save the resulting information as saved data 114. The saved data 114 can be maintained locally, synchronized to remote systems 104 by the GUI engine application 108 over the network 106, or discarded, depending on the saved data. For example, a sales representative can access a sales tool application bundle stored locally on the user device, interact with the tool to generate an invoice, and store the invoice as saved data 114. The invoice can be printed, faxed or transmitted electronically to a customer. Later, when the sales representative is coupled to the network 106, the saved data 114 can be synchronized to data stored in remote systems, in order to record the order, debit the customer's account, adjust inventory, begin the fulfillment process, and so on. Thus, the GUI engine application 108 allows a user to function in both on-line (connected to the remote systems 104 via the network 106) and off-line (disconnected from the network 106 as a stand-alone application) modes.

Remote systems 104 may include one or more web servers 116, an application server 118, a GUI engine database 120, and application data 122. The web servers 116, for example, may provide a web-based interface for user interaction using a web-browser to access and download the GUI engine application. Application server 118 distributes the GUI engine application 108 and may also be used to distribute application bundles 110 on demand. The application server 118 can also run server-based applications. The GUI Engine database (DB) 120 stores data files, application bundles and help contents. The GUI Engine database (DB) 120 may assign or add a date parameter to data or application bundles, as they are retrieved. The data parameter can be, for example, a last modified data, an expiration date, and the like. The GUI engine application 108 can make use of the date information to prevent use of old or expired data or to warn a user before use of an expired application bundle. Additionally, data associated with one or more of the application bundles or associated with an enterprise system, for example, may be stored in a database 122, accessible through the web servers 116. Though the GUI Engine DB 120 and database 122 are depicted as single data stores, it should be understood that the data, application bundles, associated help contents, and other information may be stored in multiple databases and served from multiple application servers 118 and/or web servers 116. In one embodiment, the application server 118 is a Sun Microsystems Java System Application Server (or J2EE application server). Other application servers may also be used.

In general, the GUI engine application 108 takes an application screen bundle 110 and a data table 112 and builds a portable object-based user interface. The GUI engine application 108 builds the user interface without compiling the application bundle 110, by parsing the application bundle 110 to retrieve data, objects, and business logic. This allows for simple changes in logic, data, equation values, reports, and the like, to be introduced quickly.

In one embodiment, the GUI engine application 108 takes an extensible schema definition (XSD) and one or more eXtensible Markup Language (XML) files and builds a user interface related to the XSD and XML files. Generally, the XSD can specify a grammar of the markup allowed in an extensible Markup Language (XML) file. For instance, the XSD can define an ordering of elements and/or permissible relationships between elements to place constraints that provide uniformity in the organization of data. In one embodiment, the XSD specifies how to build a user interface, such as a form window, created by the GUI engine application 108. Generally, the XML file can describe equations and values for at least some of the fields in a form, for example. Additionally, the XML file or files can contain external data to be used in completing equations within the user interface. The GUI engine application 108 can also include common functions such as print, load, save, and the like, so that new logic application bundles can be created without having to rewrite common code, thereby reducing time to market for new information technology products and for updates to existing applications.

In one embodiment, the remote systems 104 may include a configurable parser in one of the servers 116 or 118 for processing data uploaded from a client device to the servers. The configurable parser can extract data and process the uploaded files for reporting purposes, for example.

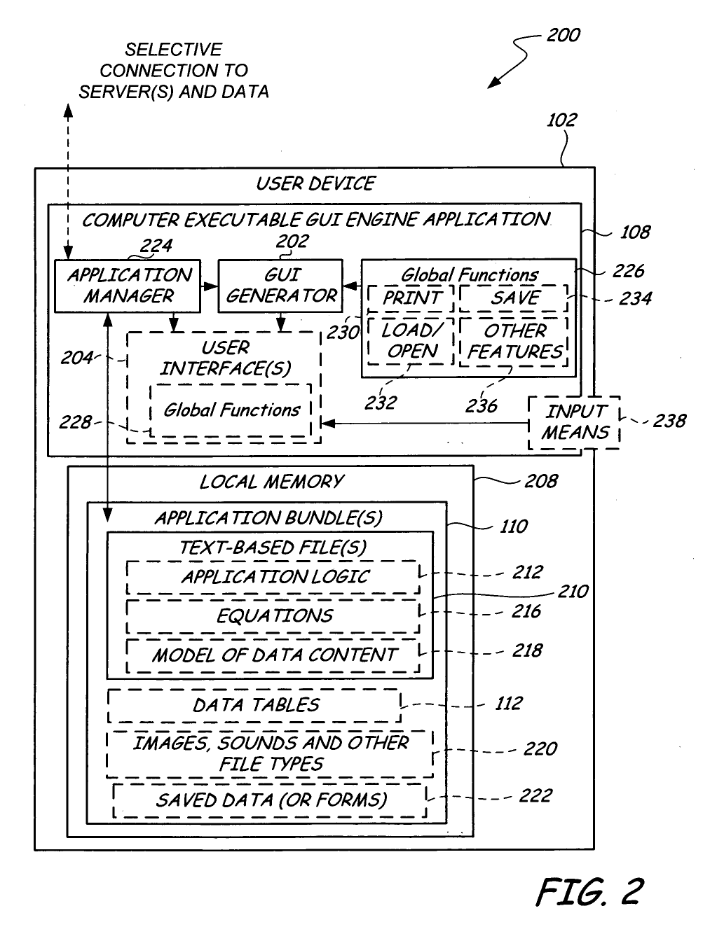

FIG. 2 illustrates a simplified expanded block diagram of a system 200 for dynamic creation of user interfaces for on-line or off-line user interactions. The system 200 includes a user device 102 that is selectively connected to one or more servers, such as the remote systems 104 in FIG. 1, and associated application data, such as the date stored in the GUI engine DB 120 and/or database 122.

The user device 102 includes a computer executable GUI engine application 108 having a GUI generator 202 adapted to dynamically generate user interfaces 204 based on application bundles 110 stored in local memory 208 and selected by a user. In general, the application bundles 110 include text-based files 210 that can define application logic 212, equations 216, and models of data content 218 for a particular application interface. The models of data content 218 may define a data structure for particular types of information, such as a product model, for example. Additionally, the text-based files 210 can include data tables 112 associated with the particular user interface 204. In some instances, local memory 208 may also contain video, images, sounds, and/or other types of multi-media file types 220 and saved data or forms 222, such as the saved data 114 in FIG. 1, for example.

The computer executable GUI engine application 108 includes a GUI generator 202 adapted to generate user interfaces 204 from selected application bundles 110. The GUI engine application 108 also includes an application manager 224 adapted to manage, for example, processor resources dedicated to each of the one or more user interfaces 204, user interactions and/or data sharing between the one or more user interfaces 204, and the like. Additionally, the application manager 224 is adapted to synchronize data between the local memory 208 and remote servers when a network connection is established and to update application bundles 110 if a newer version of a stored application bundle 110 exists on the server. Further, on selection of a particular application bundle 110 for generating a user interface 204 from the computer executable GUI engine application 108, the application manager 224 may select a best available version of the selected application bundle 110. If a network connection is established, the application manager 224 verifies that the stored bundle is a most current version, and downloads a more current version to replace the stored version if a more current version exists. Additionally, if the network is unavailable but the user device 102 has not connected to the network for a pre-determined period of time, the application manager 224 may prevent creation of the user interface 204 from the stored application bundle 110 and associated data tables 112 until the version can be verified against the network version.

The GUI engine application 108 also includes one or more global functions 226, such as a print function 230 for printing a form, a load/open function 232 for opening saved data 222 from the local memory 208, a save function 234 for saving data to the local memory, and/or other features 236 that may be common to any user interface. These global functions 226 are incorporated into the user interfaces 204 as illustrated by global functions 228. Since particular functions are common to many different applications, the global functions 226 remove the need for much of the “shell ” programming, so that business logic rules and functionality can be the focus of coding efforts. The other features 236 can include, for example, a method of converting file types into a proper format for the GUI engine application 108 to read. For example, a Microsoft Excel file can be converted by a global feature 236 to allow non-IT product specialists to model the inputs and the functionality in Excel and to provide the model to the system 200 for conversion and use in the GUI engine application 108.

An input means 238 communicatively coupled to the user device 108 or incorporated into the user device 108 can be utilized by a user to interact with elements, data, application specific functions and/or the global functions 228 within any of the one or more user interfaces 204. An input means 238 can include a keyboard, a mouse, a pen or pointer device, a touch-sensitive display, a remote control, or any other type of device adapted for user input. For example, in one embodiment, the user device 108 may be adapted for speech recognition, in which case the input device 238 can be a microphone.

The applications defined in the application bundles 110 are also portable, meaning that they can operate un-tethered from a network. For example, upon downloading of an application bundle 110, associated data is also retrieved and downloaded. Thus, a sales specialist can access an application locally and generate pricing estimates and/or sales orders on site at a client's office, without accessing a network. This allows for immediate responsiveness to a client's needs, without requiring that the sales specialist return to his or her office to reconnect to the network in order to build the price estimate.

In one embodiment, the data tables 112 can be set to expire after a period of time. The application manager 224 manages the GUI generator 202 to prevent generation of an interface 204 containing expired data. Though the GUI engine application 108 is adapted to operate on-line or off-line, the GUI engine application 108 is adapted to enforce at least periodic updates. For example, if a sales specialist fails to log onto the network within a predetermined period of time, the data tables will expire and the application manager 224 prevents the sales specialist from providing pricing quotes with outdated information.

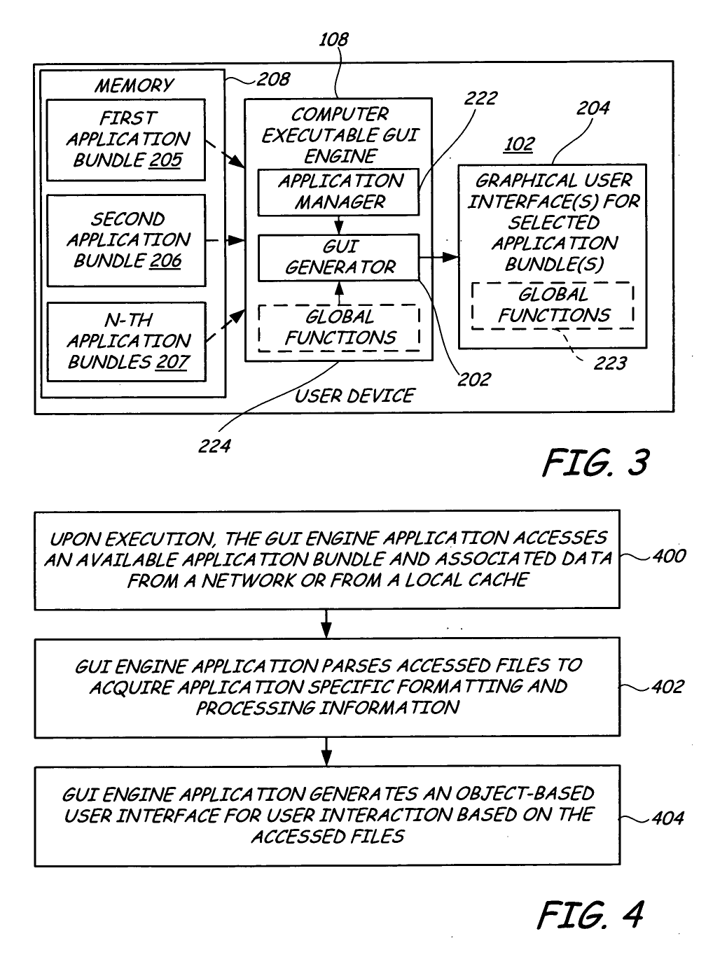

FIG. 3 is a simplified block diagram of the user device 102 with a plurality of application bundles 205-207 stored in memory 208. The application manager 222 of the computer executable GUI engine 108 controls operation of the GUI generator 202 to generate graphical user interfaces 204 for selected application bundles 205-207 and manages resources of the user device 102 with regard to each generated interface 204. As shown, global functions 224 are incorporated into each of the interfaces 204. For example, application bundle 205 can be a sales tool application. Application bundle 206 can be a customer service application. Application bundle 207 (the n-th application bundle) can be, for example, a total cost of ownership tool. Depending on the implementation, each application bundle 205-207 can provide different functions.

FIG. 4 is a simplified flow diagram of a process for dynamic generation of a user interface according to an embodiment of a GUI engine application. Upon execution of the GUI engine application, the GUI engine application accesses an available application bundle(s) and associated data from a network or from memory. (step 400) The GUI engine application parses accessed files to acquire application specific formatting and processing information. (step 402). The GUI engine application generates an object-based user interface for user interactions based on the accessed files. (step 404).

In one embodiment, the GUI engine application is adapted to detect an expiration date or a “last modified ” date property, for example, of either the data tables 112 or of a selected application bundle 110. Some file systems track properties associated with files, such as creation date, last modified date, and the like, which can be used by the GUI engine application. For example, if data in a data table is expired or if the client device has not interfaced to a remote system within a predetermined time period (as indicated for example by a last updated date field or property of the data table 112 or bundle 110), the GUI engine application can prevent creation of a user interface that may have expired data, thereby forcing the user to connect to a network to retrieve updated data. In this instance, the GUI engine application can display a message to the user indicating that the data tables 112 and or the application bundle 110 needs to be updated from the server. Alternatively, during a beta testing phase of a new application bundle, an expiration date could be set on an application bundle to disable the business logic, thereby forcing the user to connect to a network and upgrade the application bundle before using it. In particular, an application manager 224 can check for upgraded application bundles and updated data tables each time the user device is coupled to one of the remote systems 104. Since the GUI engine application reduces development time, it may be desirable to provide expiration logic on the beta application bundles in order to accelerate testing and upgrade phases.

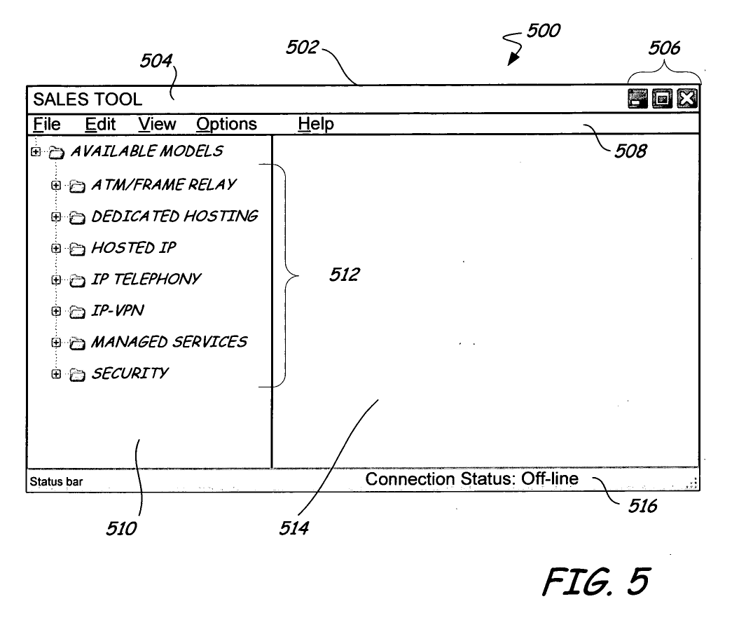

FIGS. 5-9 illustrate a user interface 500 generated by a GUI engine application from a sales tool application bundle for off-line operation. The sales tool application interface 500 includes a window 502 for receiving user input signals. The window 502 has a frame 504 with buttons 506 for closing, minimizing or restoring the window 502. Additionally, the window 502 contains a menu bar 508, a task pane 510 containing a list of available models 512, and an activity pane 514 for interacting with selected options. The window 502 also includes a status bar 516 adapted to indicate a current connection status for the particular user interface 500.

In general, the menu bar 508 includes pull down menus. In this instance, the pull down menus include a File menu, an Edit menu, a View menu, an Options menu, and a Help menu. Particular functions within each menu may be defined within the application bundles 110 or may be included within global functions 226. For example, print, save and open functions, which often appear under a File type menu in Microsoft Windows-based applications, may be generated by a GUI engine application 108 based on the global functions 226. In this manner, common functions need not be recreated for each application bundle 110. Moreover, the menu options can be displayed uniformly across multiple applications. Other functions that do not apply to all application bundles 110 may be defined within the particular application bundle. Help files and options under a Help menu can vary. Moreover, the menu headings may vary, depending on the specific application.

Application bundles can define new menu headings, add functions to existing menus, or even remove particular headings. The GUI engine application 108 generates a user interface 204 for each application bundle 110 according to the instructions contained within the application bundle 110.

Within task pane 510, the list of available models 512 can be provided by a single application bundle 110 such as a sales tool application bundle. Alternatively, the task pane 510 can host a list of available applications derived from application bundles 110. If the list is of applications, then selection of a particular application causes the GUI engine application 108 to generate the selected user interface, which may include a list of models 512. If a particular model from the list of models 512 is selected by a user, then the GUI engine application 108 generates the selected model.

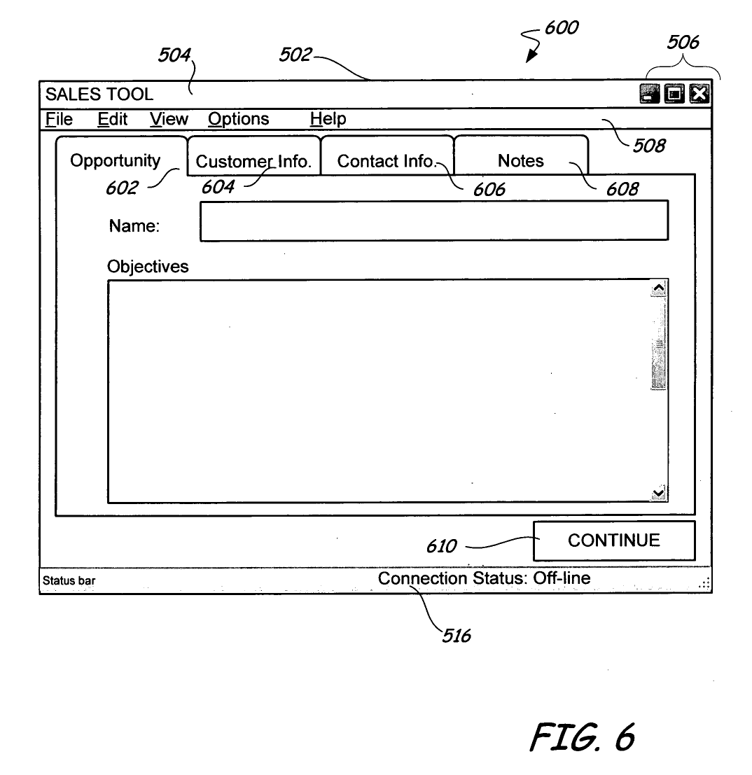

FIG. 6 illustrates a properties data entry form 600 for a selected model from the list of models 512. The form 600 includes a menu bar 508 with a plurality of user selectable options. The form 600 also includes tabs 602, 604, 606 and 608 generated from computer readable instructions associated with the application bundles. The form 600 includes an opportunity tab 602 allowing a user to enter information to provide a means for tracking, searching and reporting purposes. The form 600 also includes a customer information tab 604, a contact information tab 606, and a notes tab 608. The user can add data to form 600 within a selected tab 602, 604, 606 or 608, and press a continue button 610 when finished.

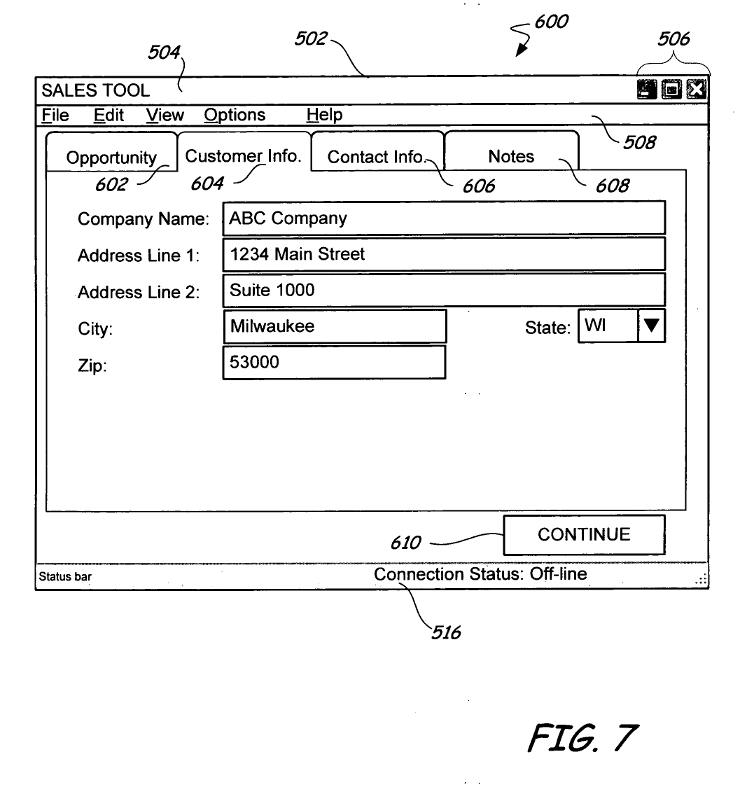

FIG. 7 illustrates selection of a customer information tab 604 that provides fields for user entry of customer data, such as address information. Contact information tab 606 provides a form for user entry of customer specific contact information, such as primary and secondary contact names and associated telephone, email and fax information, for example. The notes tab 608 provides a text entry form for entering notes a user may wish to record. Once the user has finished interacting with the tabs 602, 604, 606, and 608, the GUI engine application 108 produces a user interface for the selected model.

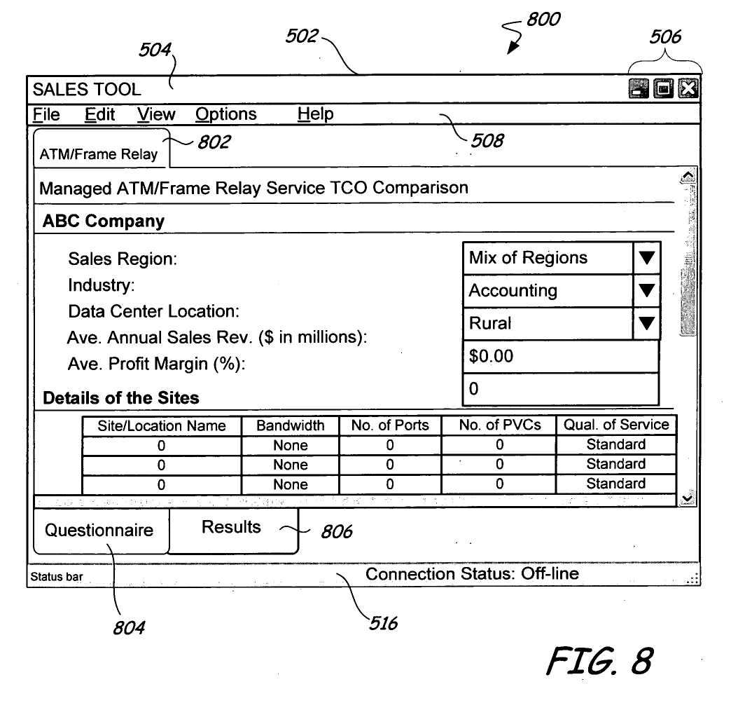

FIG. 8 illustrates a sales tool ATM/Frame Relay interface 800 within window 502. The interface 800 includes an application tab 802. If multiple applications are being accessed by a user, then an application tab 802 can be displayed for each of the multiple applications, and the user can select between the multiple applications using the application tabs 802. The ATM/Frame Relay tab 802 includes a questionaire module accessible through Questionaire tab 804 and a results module accessible through a Results tab 8046. The user can make selections, add quantities and other information in the various fields provided, and the generated application performs calculations responsive to user selections and data changes. In this way, the application responds as if it were connected to the network, providing a consistent user interface regardless of the network connection status of the user's device.

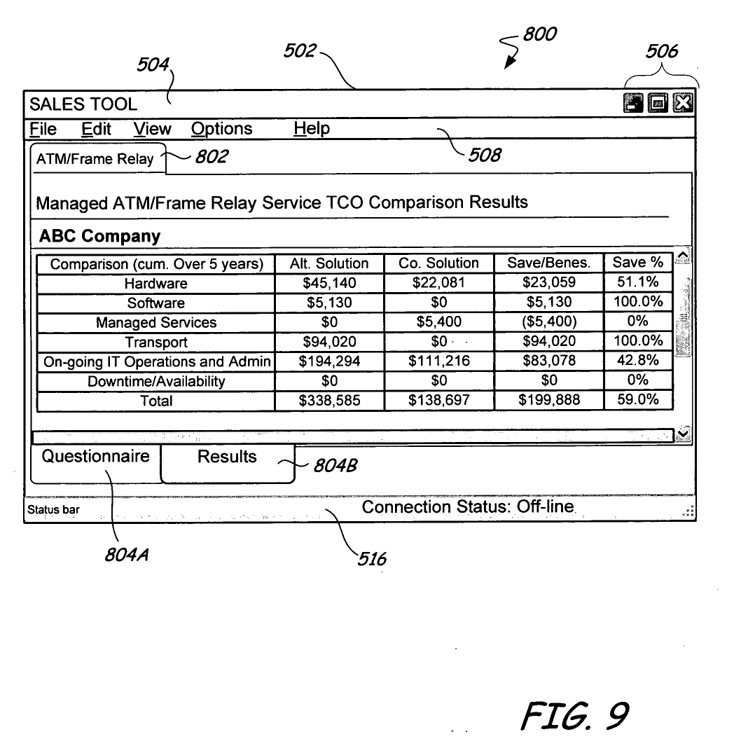

FIG. 9 illustrates a sales tool ATM/Frame Relay interface 800 with the results module selected. As shown, based on user selections made in the questionaire form shown in FIG. 8, the application performs the various calculations to provide a fully functioning application.

In one embodiment, a GUI engine application 108 provides a cascading equation processor (solver) that updates information and solves equations within each selected application bundle based on user changes and as the changes are made. Thus, each selected application operates and performs the calculations independent from a network connection of the user's device. This allows for a portable application, which utilizes downloadable program logic and is adapted to operate with or without a network connection.

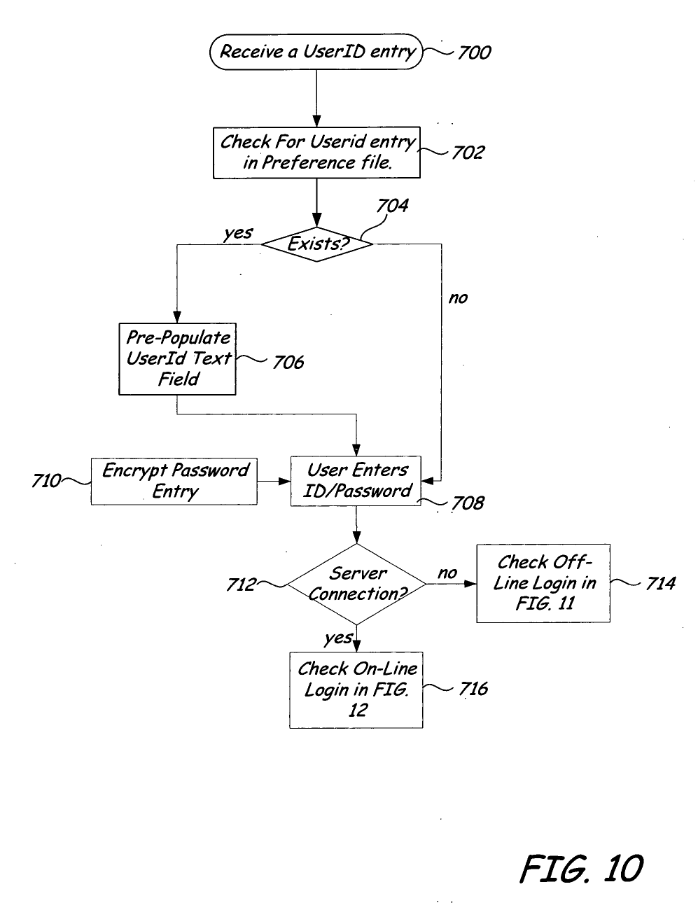

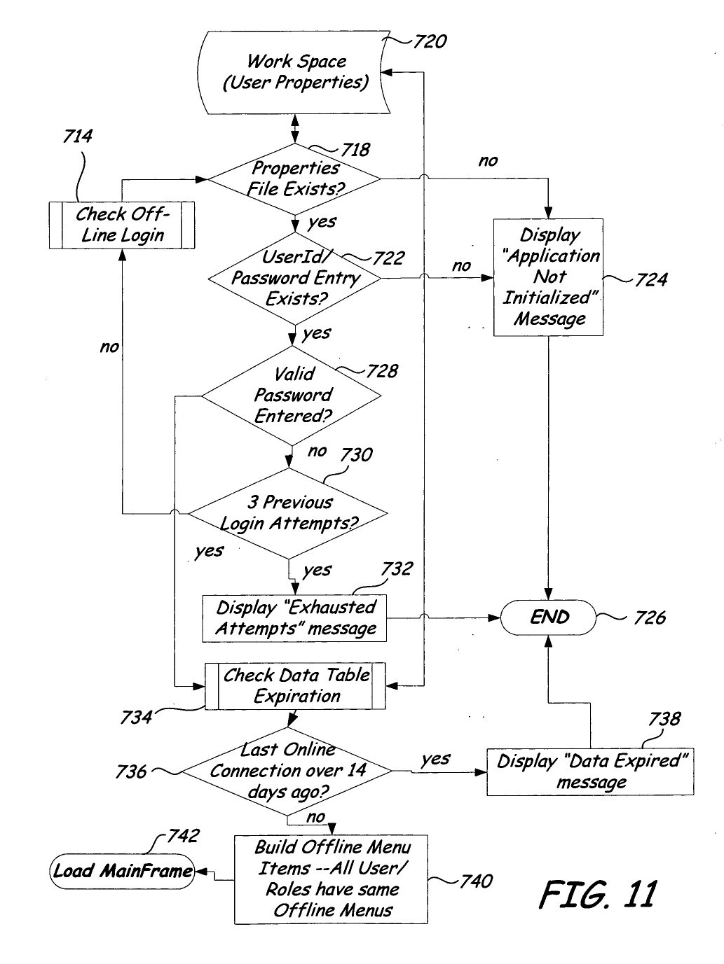

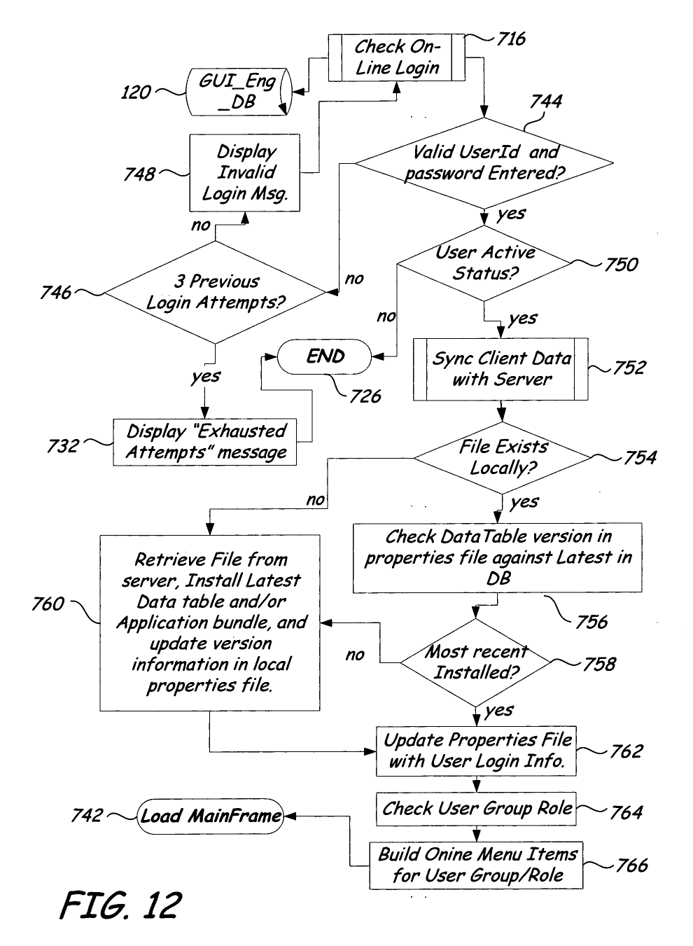

FIGS. 10-12 illustrate a login process for accessing a selected application bundle using a particular embodiment of a GUI engine application. The GUI engine application receives a UserlD entry (step 700). The GUI engine application checks for a User id entry in a preference file within a memory of the user device (step 702). If the User id entry exists in the preference file (step 704), then the GUI engine application pre-populates the User id text field (step 706). If the User id entry does not exist (step 704), then the user enters the ID and password (step 708). Password entry is encrypted (step 710). The GUI engine application checks for a connection to a server (step 712). If a server connection is unavailable, the GUI engine application proceeds with Off-Line login (step 714), which is discussed in reference to FIG. 11. If a server connection is available, the GUI engine application uses an On-line login (step 716), discussed in reference to FIG. 12.

FIG. 11 illustrates an Off-Line login process beginning at block 714 in FIG. 10A. The GUI engine application checks to see if a properties file exists for the user who is logging in (step 718). In one embodiment, the GUI engine application checks user properties within a work space (step 720). If the property file exists, the GUI engine application checks if the User id password entry exists (step 722). If either the user properties don't exist or the User id password doesn't exist, then the GUI engine application displays an “application not initialized ” error message (step 724) and terminates execution (step 726). If the UserID/password does exist, then the GUI engine application checks if a valid password was entered (step 728). If an invalid password was entered, the GUI engine application checks if there have been three previous failed login attempts (step 730). If there have been three failed login attempts, the GUI engine application displays an “Exhausted Attempts ” message (step 732) and terminates execution (step 726).

If a valid password was entered (step 728), the GUI engine application checks for data table expiration (step 734). If the last on-line connection exceeds a permitted time period (e.g. over 14 days ago) (step 736), the GUI engine application displays a “Data Expired ” error message (step 738) and terminates execution (step 726). Otherwise, the GUI engine application builds Off-line menu items for user interaction (step 740). Upon connection to a server, the GUI engine application loads updated data to a server or mainframe, for example (step 742).

In FIG. 12, a process for on-line checkin is described, beginning at step 716 in FIG. 10A. The GUI engine application checks a received UserID and password against data in the GUI engine database 120 (also shown in FIG. 1) (step 744). If the UserID and password are not valid, the GUI engine application checks if there have been three previous failed login attempts (step 746). If not, then the GUI engine application displays an “invalid login ” message (step 748) and returns to step 716 for a new UserID and/or password.

If the GUI engine application determines that there have been three previous failed login attempts (step 746), the GUI engine application displays an “Exhausted Attempts ” message (step 732) and execution is terminated (step 726).

If a valid UserID and password was entered (step 744), the GUI engine application checks whether the user is an active user (step 750). If the user is not active, then the GUI engine application terminates execution (step 726). Otherwise, the GUI engine application synchronizes client data on the client device with data on a server (step 752). The GUI engine application checks to see if a selected application file exists locally (step 754). If it does, the GUI engine application checks a version property associated with the local data table (step 756). If the file does not exist locally (step 754) or if the file is not the most recent or best available version (step 758), the GUI engine application retrieves the file from the a remote server and installs the latest data table and/or application bundle and updates the associated properties with the new version information (step 760). The GUI engine application updates the properties file with user login information (step 762), such as user role, date, and the like. The GUI engine application checks a group role associated with the user (step 764). The GUI engine application builds On-line menu items for the user (step 766), which may be based in part on a role of the user. For example, if the user is an Administrator, he or she may be given access to fields that would otherwise be unavailable to other users. Alternatively, the GUI engine application may build read-only fields for read-only access based on one user's role, while building editable fields for the same information based on another user's role. Changes to data can be loaded to the mainframe or remote server as desired (step 742).

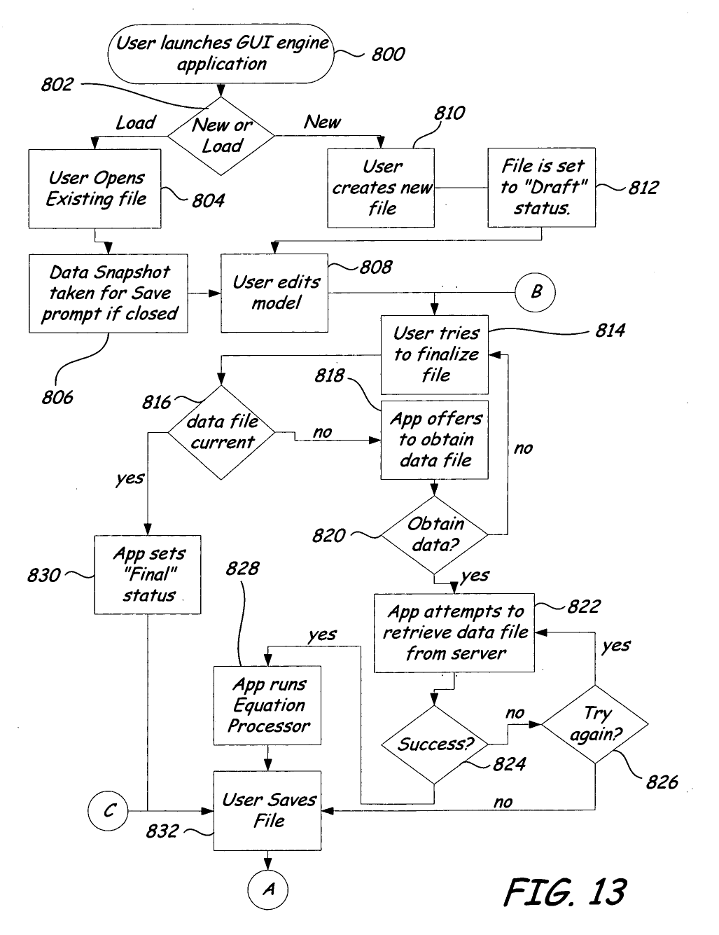

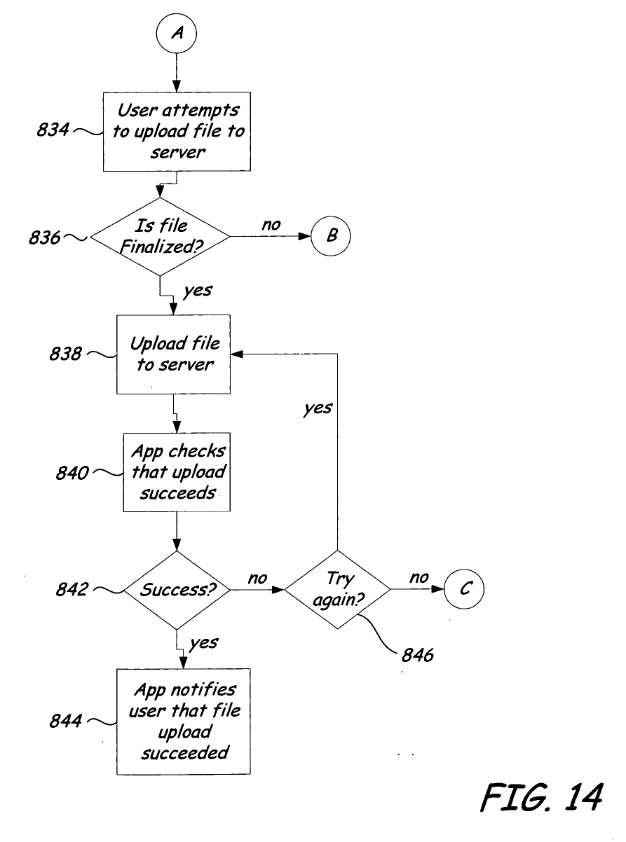

FIGS. 13 and 14 illustrate a flow diagram for operation of a GUI engine application according to a particular embodiment. Upon startup of the GUI engine application (step 800), the GUI engine application queries a user if the user wishes to create a new file or load an existing file (step 802). In one instance, the user opens an existing file (step 804), a data snapshot is taken by the GUI engine application for triggering a “save prompt ” if the application is closed (step 806), and the GUI engine application generates a user interface displaying a model based on the selected model for user interactions.

Otherwise, the user creates a new file (step 810), the GUI engine application sets the file status to “draft ” (step 812), and the GUI engine application generates a user interface displaying a model associated with the selected new draft.

The user edits the model or data within the file (step 808). The user attempts to finalize a file (step 814). If the file is a form, the form may define data entry verification steps before allowing the user to save the file. For example, the file may prevent saving unless the phone number has 10 digits for a U.S. telephone number, in order to prevent incomplete entry of contact information for example.

The GUI engine application verifies if the data file is current (step 816). If the file is not current, the GUI engine application offers to obtain a more current data file (step 818). If the user declines (step 820), the GUI engine application returns the state of the application to 814. Otherwise, the GUI engine application attempts to retrieve data file from a server (step 822). If the download fails (step 824), the user is prompted whether to try again (step 826). If yes, the GUI engine application again tries to retrieve the data file (step 822). Otherwise, the user saves the file locally (step 832). If the data file is current (step 816), the GUI engine application sets the file to “final ” status (step 830) and the user saves the file (step 832).

Referring to FIG. 14, once the file is saved (step 832), the user attempts to upload the file to a server (step 834). The GUI engine application verifies whether the file to be uploaded has been finalized (step 836). If not, the user is returned to point B in FIG. 13. If the file is finalized, the file is uploaded to the server (step 838). The GUI engine application checks to make sure that the upload succeeded (step 840). If the upload is successful (step 842), the GUI engine application notifies the user that the file upload succeeded (step 844). Otherwise, the user is prompted whether to try uploading the file again (step 846). If yes, the GUI engine application again uploads the file to the server (step 838). If no, the GUI engine application returns the state of the file to point C in FIG. 13.

Generally, embodiments of a GUI engine application may be adapted to provide a cascading equation solving functionality, whereby user-based changes to a form are promulgated throughout the application. Thus, a change in price of one item can change totals throughout the form, instantaneously. Additionally, embodiments of a GUI engine application can provided automatic update and synchronization upon connection to a network (with or without a user executing the GUI engine application). In another embodiment, a GUI engine application is adapted to prohibit use of expired data tables and/or to monitor usage to enforce at least periodic check in by the user. In this instance, the GUI engine application may be considered a quasi-un-tethered application wherein application instances can be generated during off-line status for a period of time, after which the user must check back into the network to “synch-up ” or update data and/or application files.

The GUI engine application provides a common application programming interface (API) to which business rules can be written. The GUI engine application may then serve as a business rules container for executing and enforcing business rules and for displaying data and receiving associated user inputs. This allows frequent business rules updates without requiring re-coding of the application, since the business rules can be served to the GUI engine application as text-based application bundles, in a predefined format. Such predefined formats may include extensible Markup Language (XML) formats or other tag-based markup formats, field delimited formats, or other types of pre-defined data and rules structures, which may be easier for a business executive to understand than standard object-based software code that requires compilation by a compiler. The GUI engine can use the text-based files to dynamically assemble a user interface, defined in the text-files, for on-line or off-line interaction. Moreover, the GUI engine can merge the text-based files with predefined global functions (such as print, save, load, and the like) to provide a common user interface across a suite of applications assemble from such application bundles.

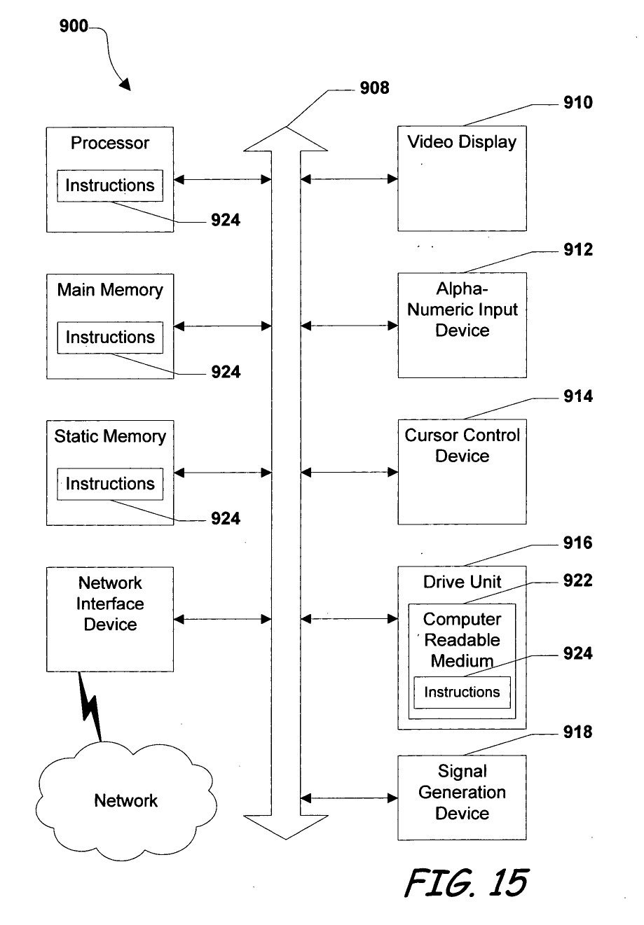

Referring to FIG. 15, an illustrative embodiment of a general computer system is shown and is designated 900. The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system ” shall also be taken to include any collection of systems or sub-systems that individually or jointly execute a set, or multiple sets, of instructions to perform one or more computer functions.

As illustrated in FIG. 15, the computer system 900 may include a processor 902, e.g., a central processing unit (CPU), a graphics processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment, as depicted in FIG. 15, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video or data over the network 926. Further, the instructions 924 may be transmitted or received over the network 926 via the network interface device 920.

While the computer-readable medium is shown to be a single medium, the term “computer-readable medium ” includes a single medium or multiple media, such as a centralized or distributed database, and/or associated caches and servers that store one or more sets of instructions. The term “computer-readable medium ” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

With the configuration of structure described above, the system and method of a computer executable graphical user interface engine provides a way to dynamically generate a graphical user interface related to text-based files. Further, both on-line and off-line modes of operation are available. Moreover, data for use off-line can be set to expire after a predetermined period, and the computer executable graphical user interface engine can enforce expiration settings to prevent user interactions with expired data. Additionally, the computer executable graphical user interface is adapted to download updated application bundles and data when connected to a remote server, and to upload stored data to the server based on user interactions.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention ” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

It will be apparent to those skilled in the art that the disclosed embodiments may be modified in numerous ways and may assume many embodiments other than the particular forms specifically set out and described herein. The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer executable application for use on a user device, the computer executable application comprising:
a computer executable graphical user interface engine to receive one or more text-based files and to generate a user interface having an input form at least partially populated with data from the one or more text-based files, the computer executable graphical user interface engine adapted to enforce updates retrievable via a network from a remote device based on date information related to the one or more text-based files.

2. The computer executable application of claim 1 wherein the date information comprises an expiration date related to usage limitations of the user interface based on data from at least one of the one more or more text-based files.

3. The computer executable application of claim 1 wherein the computer executable graphical user interface engine adapted to enforce updates at least periodically.

4. The computer executable application of claim 1 wherein the date information comprises a date property of at least one of the one or more text-based files.

5. The computer executable application of claim 4 wherein the computer executable graphical user interface engine prohibits creation of the user interface when a difference between a current date and a last modified date is greater than a predetermined number of days.

6. The computer executable application of claim 4 wherein the computer executable graphical user interface engine is adapted to communicate with the network to retrieve updated versions of the one or more text-based files when a difference between a current date and a last modified data is greater than a predetermined number of days.

7. The computer executable application of claim 1 wherein at least one of the one or more text-based files comprises:
an extensible markup language schema declaration specifying a markup grammar of an application; and
an extensible markup language data file comprising external data for completing fields within the input forms.

8. The computer executable application of claim 7 further comprising:
an extensible markup language file defining equations and values for use with the equations within the input forms.

9. The computer executable application of claim 1 wherein the computer executable graphical user interface engine allows a user to store a user modified data file on the user device.

10. The computer executable application of claim 9 wherein the computer executable graphical user interface engine is selectively coupled to a networked server for communicating the user modified data file to the server.

11. The computer executable application of claim 1 wherein the one or more text-based files are stored in a local memory and wherein the computer executable graphical user interface engine is selectively coupled to at least one remote server for replacing a locally stored version of the one or more text-based files with a replacement version from the server.

12. The computer executable application of claim 1 wherein the computer executable graphical user interface engine generates the user interface without compiling the one or more text-based files.

13. A computer executable application on a user device, the computer executable application comprising:
a plurality of application bundles, each application bundle of the plurality of application bundles comprising at least one associated text-based file defining application logic for a particular application; and
a graphical user interface engine adapted to receive selected application bundles of the plurality of application bundles and to generate corresponding user interfaces, each of the user interfaces including customizable features defined by each of the selected application bundles and including at least one user selectable function common to each of the user interfaces.

14. The computer executable application of claim 13 further comprising:
an application manager adapted to manage each respective user interface.

15. The computer executable application of claim 13 wherein at least one application bundle of the plurality of application bundles comprises an image file.

16. The computer executable application of claim 13 wherein at least one application bundle of the plurality of application bundles comprises a data file.

17. The computer executable application of claim 15 wherein at least one application bundle of the plurality of application bundles comprises a text based file defining application logic for manipulating the data file and for processing user interactions with the user interface.

18. The computer executable application of claim 13 wherein the graphical user interface engine is selectively coupled to a server over a network connection and is adapted to download one or more of the plurality of application bundles from the server for storage in a local memory and wherein the graphical user interface engine is adapted to receive the one or more application bundles from the local memory.

19. A method of dynamically assembling an application from a text-based file, the method comprising:
receiving at least one text-based file with a computer executable graphical user interface engine;
checking a local properties file of the at least one text-based file to determine whether the at least one text-based file is valid; and
when the at least one text-based file is determined to be valid, building a user interface having an input form at least partially populated with data from the at least one text-based file.

20. The method of claim 19 wherein the step of checking comprises:
determining a difference between a date of a last modified date property of the local properties file and a current date; and
generating an error message if the difference is greater than a predetermined number of days.

21. The method of claim 19 wherein the step of checking comprises:
determining an expiration date of the at least one text-based file; and
generating an error message if the expiration date is equal to or greater than a current date.

22. The method of claim 19 wherein the step of building the user interface comprises:
extracting data and formatting information from the at least one text-based file; and
constructing the user interface from the extracted data and formatting information, the user interface comprising user selectable objects defined by the data and formatting information and user selectable functions provided by the graphical user interface engine.

23. A user device comprising:
a processor;
a memory adapted to store one or more application bundles; and
an executable graphical user interface engine application executable by the processor, the executable graphical user interface engine to receive one or more application bundles and to generate a user interface having input forms at least partially populated with data from the one or more application bundles, the input forms including business logic defined by the one or more application bundles.

24. The user device of claim 23 further comprising:
a network interface adapted for communication with a network, wherein the executable graphical user interface engine retrieves at least one of the one or more application bundles from the network.

25. A system comprising:
an application server to distribute a computer executable graphical user interface (GUI) engine application to a remote device; and
a GUI database to store application bundles and to distribute selected application bundles to the remote device, each of the selected application bundles comprising business logic for execution by the computer executable GUI engine application, the computer executable GUI engine application adapted to generate a user interface for user interactions from at least one of the selected application bundles.

26. The system of claim 25 wherein the GUI database stores and distributes help contents related to the selected application bundles.

27. The system of claim 25 wherein the GUI database distributes data files to the remote device.

28. The system of claim 25 wherein the GUI database is adapted to assign a date parameter to each of the selected application bundles.

29. The system of claim 28 wherein the date parameter comprises a user interface usage expiration date.

30. A computer executable graphical user interface comprising:
an application window operable to display multiple user interfaces, each user interface having an input form defined by one or more text-based files and the form at least partially populated with data from the one or more text-based files; and
the application window operable to display user selectable objects for switching between the user interfaces.

31. The computer executable graphical user interface of claim 30 wherein the one or more user interfaces are defined by the one or more text-based files.

32. The computer executable graphical user interface of claim 30 wherein a particular user interface of the one or more user interfaces comprises a sales tool application interface.

33. The computer executable graphical user interface of claim 30 wherein a particular user interface of the one or more user interfaces comprises a total cost of ownership application interface.

34. The computer executable graphical user interface of claim 30 wherein a particular user interface of the one or more user interfaces comprises a customer service application interface.
